(19) United States
(12) Patent Application Publication
(10) Pub. No.: US 2025/0187408 A1
(43) Pub. Date: Jun. 12, 2025

(54) WINDLESS AIR OUTLET

(71) Applicant: Ningbo JoysonQuin Automotive Systems Holding Co., Ltd, Ningbo City (CN)

(72) Inventors: ShengFeng Zhang, Ningbo City (CN); WenLong Hu, Ningbo City (CN); QianKun Yao, Ningbo City (CN)

(21) Appl. No.: 18/975,114

(22) Filed: Dec. 10, 2024

(30) Foreign Application Priority Data
Dec. 12, 2023 (CN) 202311700363.1

(51) Int. Cl. B60H 1/34

(52) U.S. Cl. CPC B60H 1/345

(57) ABSTRACT

A three-channel windless air outlet incudes a housing including a plurality of ducts; an installation space connected to a middle air duct in the housing; and an air drainage duct located at the installation space and including an air guide chamber and a windless board covering the air guide chamber; wherein a cross-section of the air guide chamber in a first direction is trapezoidal such that an area increases in a second direction so that wind diffuses from a center to both sides during flow from an inlet to an outlet in the air guide chamber.

### CROSS-REFERENCE TO RELATED APPLICATIONS

This application claims priority to Chinese Patent Application No. CN 202311700363.1, which was filed on Dec. 12, 2023, the entirety of which is incorporated by reference for all purposes as if fully set forth herein.

### FIELD

The disclosure relates to an air outlet for a vehicle, and in particular to a three-channel windless air outlet.

### BACKGROUND

An air outlet or ventilation of a vehicle is used to guide the air blown by the vehicle climate control system into the cabin and reduce the discomfort caused by direct wind blowing on the occupants. Air treatment parts are installed in the air outlet to make the blown air softer.

The problem to be solved by the present disclosure is to provide an air outlet that can switch between conventional wind, windless wind, diverse wind modes, and a windless mode with low pressure to ensure the environment temperature in the vehicle under constant power.

### SUMMARY

In some embodiments, the technical solution provided by the disclosure to solve the above problems may include: a three-channel windless air outlet including a housing which has an air inlet duct at one side and at another side, and from top to bottom includes an upper air duct, a middle air duct, and a lower air duct. An installation space may be formed between the upper air duct and the lower air duct such that the middle air duct may be connected with the installation space.

An air drainage duct may be located at the installation space, and the air drainage duct may be connected to middle air duct. The air drainage duct may include a housing, an air guide chamber located in the housing, and a windless board covering the air guide chamber. A cross-section of the air guide chamber in the first direction can be trapezoidal, and the area gradually increases in the second direction, so that the wind gradually diffuses from the center to both sides during flow from the inlet to the outlet in the air guide chamber.

An air guide mechanism also may be included, which may include a first air guide plate and a second air guide plate. The first air guide plate may include a rotatable upper first air guide plate and a lower first air guide plate at both sides of the air inlet duct. The upper first air guide plate and the lower first air guide plate may control the air from the middle air duct. The second air guide plate may include an upper second air guide plate which may control the air from the upper air duct, and the lower second air guide plate may control the air from the lower air duct.

Compared with current technology, the windless air outlet, with an overall compact structure, may include the upper air duct, the middle air duct, and the lower air duct. The middle air duct may be independent of other conventional air ducts. The middle air duct can be connected to the installation space between the upper air duct and the lower air duct and transports the air in the middle air duct to the air drainage duct. The installation space provides a suitable installation position for the air drainage duct, and improves the space utilization rate. The cross-section of air guide chamber in the air drainage duct in the first direction may be trapezoidal, so that the wind gradually diffuses from both sides along two waists of the trapezoid during air flow to the air drainage duct, and the area of the air guide chamber gradually increases in the second direction, causing further improvement to the diffusion effect and reducing the impact of pressure drop, ensuring that the temperature environment in vehicle is under constant power. The windless air outlet also may include the upper first air guide plate and the lower first air guide plate for controlling the middle air duct, the upper second air guide plate for controlling the upper air duct, and the lower second air guide plate for controlling the lower air duct. Through the rotation of the first air guide plate and the second air guide plate, the three air ducts can be opened independently and turned together, making the air outlet modes more diverse to meet the needs of users.

An embodiment may include a three-channel windless air outlet having an air guide chamber including a middle flow channel, and symmetrical multiple side flow channels on the side of the middle flow channel. A central axis of a side flow channel and a central axis of the middle flow channel may have an inclined angle, and the angle may increase as the distance between the middle flow channel and the side flow channel gets larger.

An embodiment may include a three-channel windless air outlet having an air guide chamber that may contain multiple air guide vanes. An air guide cavity may be divided into a middle flow channel and side flow channels by multiple air guide vanes. The air guide vanes may include an inner air guide vanes and an outer air guide vane, the air drainage duct may include a windless board, and the windless board may be supported by multiple outer air guide vane.

An embodiment of a three-channel windless air outlet may include a windless board having a first windless board body with a bending forming process and a secondary windless board body. The first windless board body and the second windless board body may be arranged at an obtuse angle. The first windless board body and the second windless board body may include multiple through holes, and the through holes may be distributed from the air outlet of middle flow channel to the air outlets of side flow channels. The size of the through hole may decrease as the distance from the air outlet of middle flow channel increases.

An embodiment may include a three-channel windless air outlet. The air outlet area S1 of the upper air duct, the air outlet area S2 of the lower air duct, and the air outlet area S3 of the air drainage duct may satisfy the following relationship: S1+S2≤S3.

An embodiment of a three-channel windless air outlet may include a first air guide plate having a first plate body, a first connection structure located on the first plate body may be arranged sequentially from left to right and along the same axis, a second connection structure, and a third connection structure. The first connection structure may include a first rotating shaft and a first driving part that are connected to each other. The connection structure may include a first shaft portion, a first plate body, and a second rotating shaft arranged in sequence. The first rotating shaft and the second rotating shaft can be rotated on both sides of the air inlet duct respectively, and the first driving part may connect a driving mechanism, so that the driving mechanism causes the first air guide plate to rotate.

An embodiment of a three-channel windless air outlet may include a second air guide plate having a second plate body, a fourth connection structure, a fifth connection structure, and a sixth connection structure. The fourth connection structure may include a second driving part, a third rotating shaft, and a second shaft.

In an aspect, a first connection structure may include a through shaft hole, and the first plate body may include a first chute.

In an aspect, a third rotating shaft may be rotatably connected in the shaft hole, a sixth connecting structure may be movably connected in the first chute, and the second driving part connects to the driving mechanism so that the driving mechanism causes the second air guide plate to rotate.

An embodiment of a three-channel windless air outlet may include a second shaft inserted into an end of a second connection structure, so that the second shaft can rotate around the end of the second connection structure. The end of the fifth connection structure may be inserted into the first shaft, so that the first shaft can rotate around the end of the fifth connection structure.

An embodiment of a three-channel windless air outlet may include a middle air duct having baffle plate components. The baffle plate components may include two mounting plates at both sides of the air duct and fixed to two mounting plates. The baffle plate may divide the middle air duct into upper and lower portions. Two sets of limited protrusions at the upper and lower end surfaces of the baffle plate may connect the first air guide plate and the second air guide plate.

### BRIEF DESCRIPTION OF THE DRAWINGS

FIG. 1 is a perspective view of a windless air outlet according to an embodiment;

FIG. 2 is a side view of the windless air outlet;

FIG. 3 is a cross-sectional view of the windless air outlet;

FIG. 4 is the air outlet structure schematic diagram of the three air ducts;

FIG. 5 is a cross-sectional view of the drainage duct along the first direction;

FIG. 6 is a cross-sectional view of the drainage duct along the second direction;

FIG. 7 is the air outlet schematic diagram of the three air ducts;

FIG. 8 is a schematic structural diagram of the windless board;

FIG. 9 is a schematic structural diagram of the first air guide plate;

FIG. 10 is a schematic structural diagram of the second air guide plate;

FIG. 11 is a fit schematic diagram between the first air guide plate and the second air guide plate;

FIG. 12 is a fit schematic diagram between the first air guide plate and the housing of the second air guide plate;

FIG. 13 is a schematic diagram of baffle plate components;

FIG. 14 is a working condition schematic diagram of when the up air duct and down air duct guide air at the same time;

FIG. 15 is a working condition schematic diagram of guide air from the up air duct;

FIG. 16 is a working condition schematic diagram of guide air from the down air duct;

FIG. 17 is a working condition schematic diagram of guide air from the middle air duct;

FIG. 18 is a cross-sectional view along the second direction when guide air from the middle air duct;

FIG. 19 is a cross-sectional view along the first direction when guide air from the middle air duct;

FIG. 20 is a schematic diagram of the air guiding without diffusion;

FIG. 21 is a schematic diagram of the air guiding with diffusion;

FIG. 22 is a fit schematic diagram of the sample of the driving mechanism;

FIG. 23 is an exploded view of the sample of the driving mechanism;

FIG. 24 is a fit schematic diagram of the driving mechanism and air guide structure; and

FIG. 25 is a schematic diagram of a driving plate structure.

### DETAILED DESCRIPTION

This description of the exemplary embodiments is intended to be read in connection with the accompanying drawings, which are to be considered part of the entire written description.

It should be understood that the invention is not limited in its application to the details of construction and arrangement of components set forth in the following description or illustrated in the following drawings. The invention is capable of other implementations and of being practiced or carried out in various ways. Additionally, it is to be understood that the phraseology and terminology used herein are for the purpose of description and should not be regarded as limiting. The use of “including” or “having” and variations thereof herein is intended to cover the items set forth below and their equivalents as well as additional items. Unless otherwise specified or limited, the terms “mounted,” “connected,” “supported” and “coupled” and variations thereof are used broadly and encompass both direct and indirect mountings, connections, supports, and couplings. Furthermore, “connected” and “coupled” are not limited to physical or mechanical connections or couplings.

The terms “vertical”, “horizontal”, “upper”, “lower”, “front”, “rear”, “left”, “right”, “vertical” and orientations or positional relationships indicated by “horizontal”, “top”, “bottom”, “inner”, “outer”, etc. are based on the orientations or positional relationships shown in the drawings, which are only for the convenience of describing the present invention and simplifying the description. Rather than indicating or implying that the device or element referred to must have a specific orientation, be constructed and operated in a specific orientation, the above terms cannot be understood as limiting the invention; secondly, the term “a” should be understood as “at least one” or “one or more”, that is, in one embodiment, the number of an element may be one, and in other embodiments, the number of the element may be multiple, and the term “a” cannot be understood as a reference to quantity limitation.

A person skilled in the field should understand that the implementation of the embodiments shown in the description and drawings are only for illustration and do not limit the present invention. Without departing from the principles, the systems and methods described herein can be modified in any way or changed as will be understood by those of ordinary skill in the art.

In some embodiments, a windless air outlet includes a plurality of channels, such as two are more. In some embodiments, a three-channel air outlet may include an upper air duct, a middle duct, and a lower air duct having an overall compact structure. The wind in the middle duct may be transported to a drainage air duct, and an installation space may be provided for the drainage air duct installation. A cross-sectional shape of an air guide chamber in the drainage air duct in a first direction may be generally trapezoidal. When the wind passes through the drainage air duct, it may diffuse from both sides along the two waists of the trapezoidal shape, and the area of the air guide chamber increases gradually in a second direction, further improving the diffusion effect and reducing the impact of an air pressure drop, ensuring the temperature environment in the vehicle under constant power. The three-channel windless air outlet also may include a first upper air guide plate, a first lower air guide plate, a second upper air guide plate, and a second lower air guide plate that allow the three air ducts to be opened independently or cooperatively. Thus, the resulting air outlet modes are more diverse and can meet the needs of users.

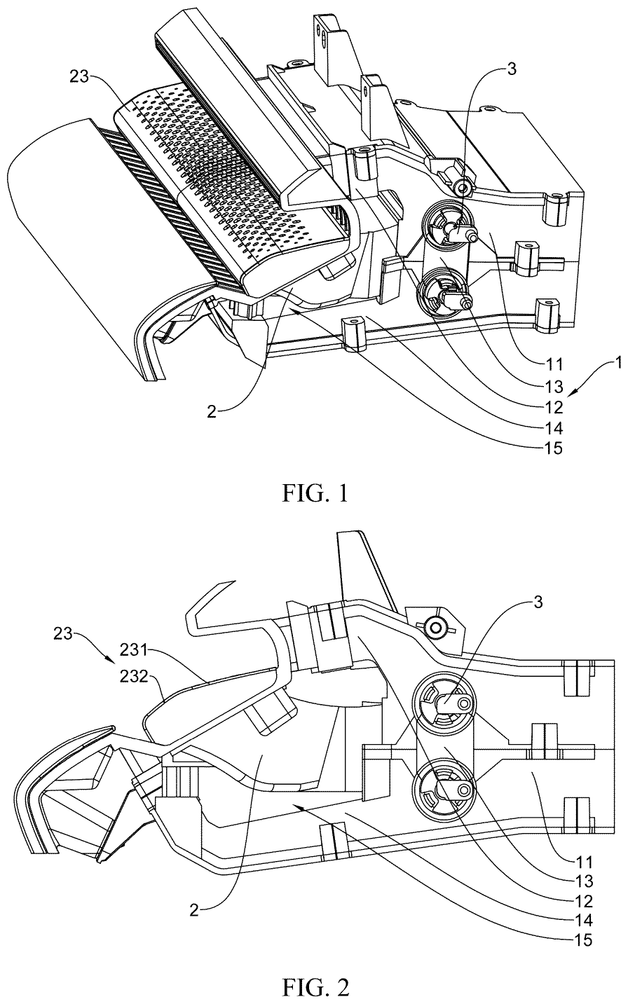

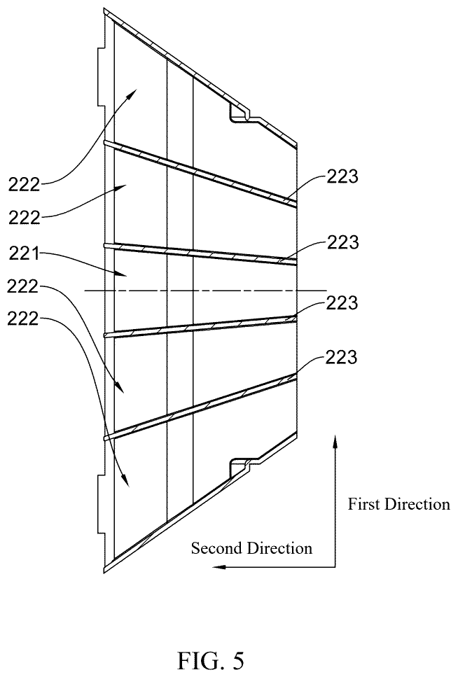

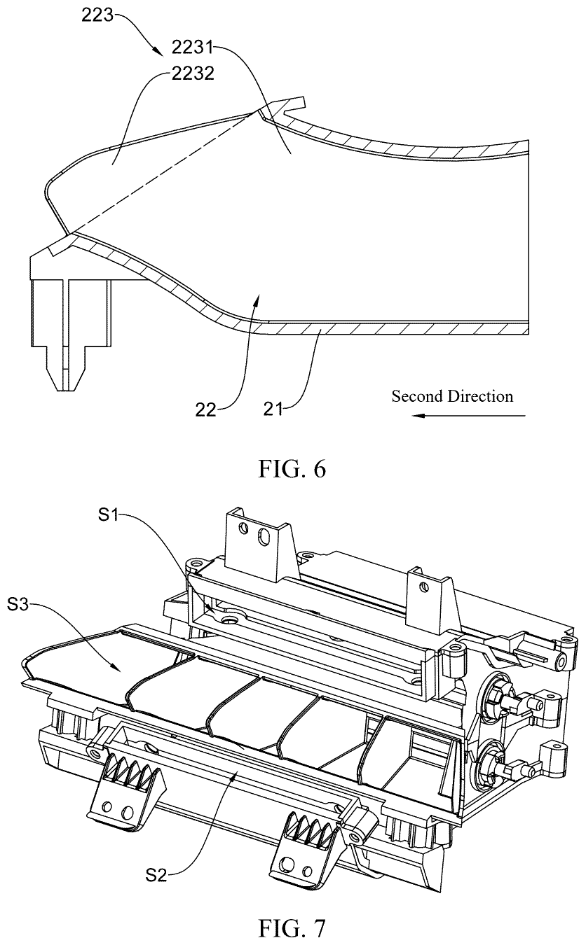

FIGS. 1 to 21 show features of one example of a multi-channel windless air outlet in accordance with some embodiments. As shown, the air outlet may include a housing 1 having an air inlet duct 11, an upper air duct 12, a middle air duct 13, and lower air duct 14; and an installation space 15 that is defined between the upper duct 12 and the lower air duct 14. The middle air duct 13 may be connected with the installation space 15.

An air drainage duct 2 can be located at the installation space 15, and the air drainage duct 2 can be connected to the middle air duct 13. The air drainage duct 2 can include a housing 21, with an air guide chamber 22 located in housing 21, and a windless board 23 covered air guide chamber 22. In some embodiments, the cross-section of air guide chamber 22 in a first direction is generally trapezoidal such that the area gradually increases in a second direction, so that the wind gradually diffuses from the center to both sides during flow from the inlet to the outlet in the air guide chamber 22.

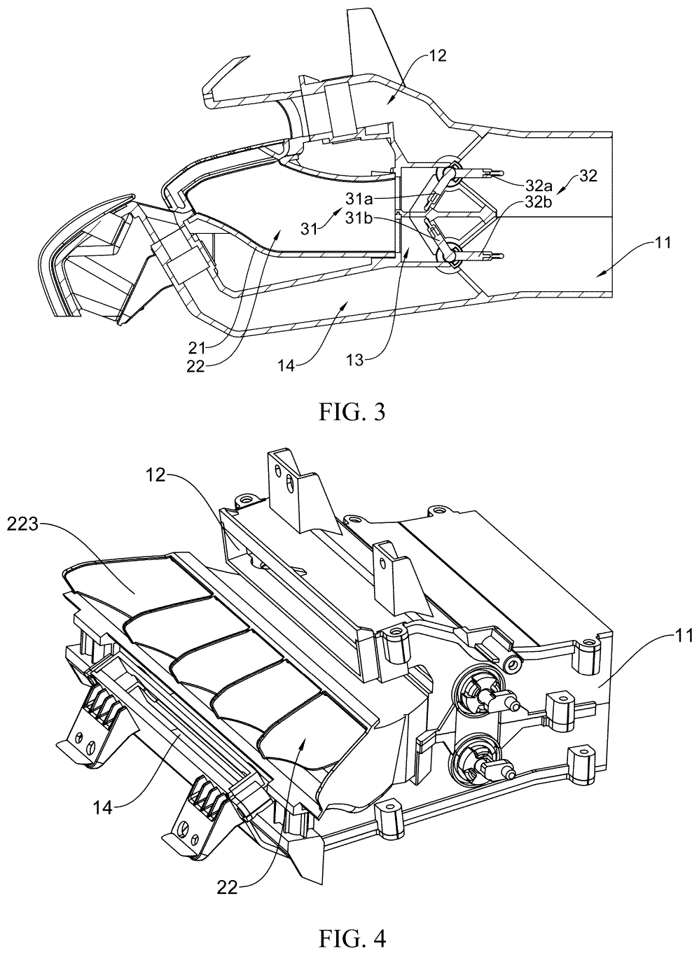

The three-channel windless air outlet can also include an air guide mechanism 3, which may include a first air guide plate 31 and a second air guide plate 32 as best seen in FIG. 3. The first air guide plate 31 may include a rotatable first upper air guide plate 31a and a first lower air guide plate 31b at both sides of the air inlet duct 11. The first upper air guide plate 31a and the first lower air guide plate 31b may control the air from the middle air duct 13. The second air guide plate 32 may include a second upper air guide plate 32a for controlling the air from the upper air duct 12, and a second lower air guide plate 32b for controlling the air from the lower air duct 14.

The windless air outlet may have an overall compact structure and includes the upper air duct 12, the middle air duct 13, and the lower air duct 14. The middle air duct 12 may be independent of other conventional air ducts. The middle air duct 13 may be connected to the installation space 15 between the upper air duct 12 and the lower air duct 14 and be configured to transport the air in the middle air duct 13 to the air drainage duct 2. The installation space 15 may provide a suitable installation position for the air drainage duct 2 and improve the space utilization rate. A cross-section of the air guide chamber 22 in the air drainage duct 2 in the first direction may be trapezoidal, so that the wind gradually diffuses from both sides along the two waists of the trapezoid during air flow to the air drainage duct 2, and the area of air guide chamber 22 gradually increases in the second direction, causing further improvement to the diffusion effect and reducing the impact of pressure drop, ensuring the temperature environment in a vehicle is under constant power. In some embodiments, the first upper air guide plate 31a and the first lower air guide plate 31b are configured to control the middle air duct 13, the second upper air guide plate 32a is configured to control the upper air duct 12, and the lower second air guide plate 32b is configured to control the lower air duct 14. Through rotation of the first air guide plate 31 and the second air guide plate 32, the three air ducts can be opened independently and turned together, making the air outlet modes more diverse and meet the needs of users.

As shown in FIGS. 4 to 6, the air guide chamber 22 can include a middle flow channel 221, and symmetrical multiple side flow channels 222 on the side of the middle flow channel 221. A central axis of the side flow channels 222 and the central axis of the middle flow channel 221 have an inclined angle, and the angle increases as the distance between the middle flow channel 221 and the side flow channel 222 gets larger.

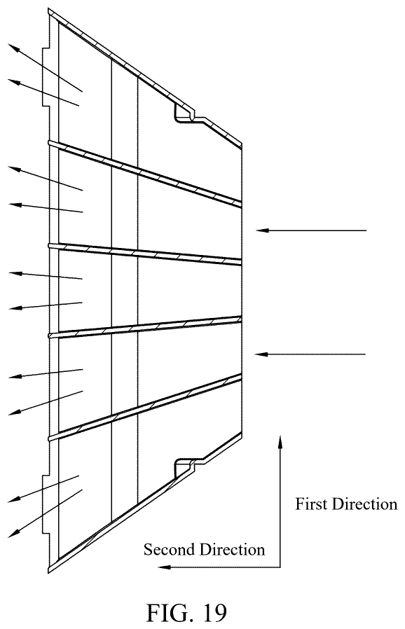

FIG. 19 shows that when air flow (represented by the arrows) passes through the air drainage duct 2, it will be guided to the middle flow channel 221 and the symmetrical multiple side flow channels 222. Since the central axis of the side flow channels 222 and the central axis of the middle flow channel 221 have an inclined angle, and the angle increases as the distance between middle flow channel 221 and side flow channels 222 get larger, the air flow at side flow channels 222 diffuse from both sides by the gradual increasing angle, enhancing a diffusion effect and reducing the impact of an air pressure drop.

FIGS. 4, 5, 6, and 19 show that the air guide chamber 22 may include multiple air guide vanes 223 such that the air guide cavity 22 is divided into the middle flow channel 221 and the side flow channels 222 by multiple air guide vanes 223. Each of the air guide vanes 223 may include an inner air guide vane 2231 and an outer air guide vane 2232. The air drainage duct 2 may include a windless board 23. The windless board 23 is supported by multiple outer air guide vane 2232.

The guiding effect of the middle flow channel 221 and the side flow channels 222 can be enhanced through the design of the air guide vanes 223 that include an inner air guide vane 2231 and an outer air guide vane 2232. As far as the implementation is concerned, the inner air guide 2231 may be configured to penetrate the air guide chamber 22 from beginning to end, so that the wind is guided throughout the entire process when passing through air guide chamber 22. When the wind blows out from the air guide chamber 22, the outer air guide vane 2232 can continue the guiding function by the inner air guide vane 2231 and allows the wind to be guided when passing through the gap between the air guide chamber 22 and the windless plate 23. In addition, multiple outer air guide vanes 2232 may be arranged in sequence along the air guide chamber 22, which is beneficial to supporting the shape of the windless board 23.

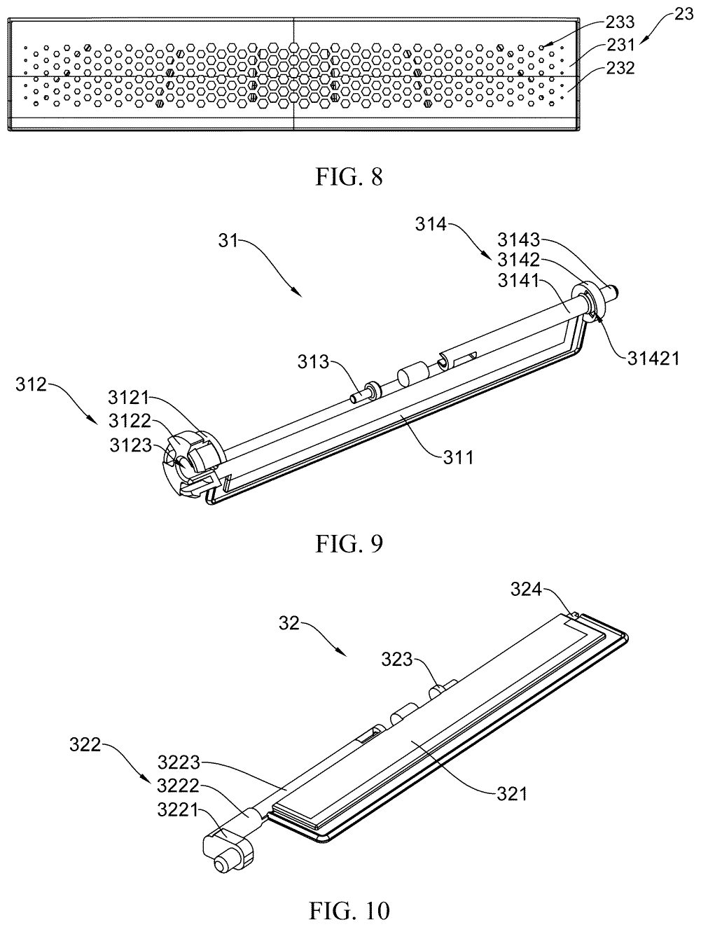

FIGS. 2 and 8 show that the windless board 23 includes a first windless board body 231 with a bending forming process and a secondary windless board body 232. The first windless board body 231 and the second windless board body 232 may be arranged at an obtuse angle. The first windless board body 231 and the second windless board body 232 include multiple through holes 233, which may be distributed from the air outlet of the middle flow channel 221 to the air outlets of side flow channels 222. In some embodiments, the size of the through holes 233 may decrease as the distance from the air outlet of the middle flow channel 221 increases.

In some embodiments, the windless board 23 may be bent into a first windless board body 231 and a second windless board body 232 arranged at an obtuse angle, so that when the wind reaches the windless board 23, it diffuses through the first windless board body 231 and the second windless board body 232 in different directions, further improving the diffusion effect and reducing the impact of pressure drop. A plurality of through holes 233 may be defined by the first windless plate body 231 and the second windless plate body 232. The wind can be softer when the wind blows out through the through holes 233, reducing the discomfort by the direct wind blowing to the human body, i.e., “windless.” In addition, the size of the through holes 233 may decrease as the distance from the air outlet of middle flow channel 221 increases, which is beneficial to the side flow channel 222 with the gradually increasing angle.

FIG. 7 shows the air outlet area SI of the upper air duct 12, the air outlet area S2 of the lower air duct 14, and the air outlet area S3 of the air drainage duct 2. In some embodiments, the air outlet S3 satisfies the following relationship: S1+S2≤S3. The air drainage duct 2 may have a better diffusion effect and smaller pressure drop compared to conventional ducts. Under constant power, the air drainage duct 2 can ensure that the temperature environment in the vehicle reaches the same level as the upper air duct 12 and the lower air duct 14.

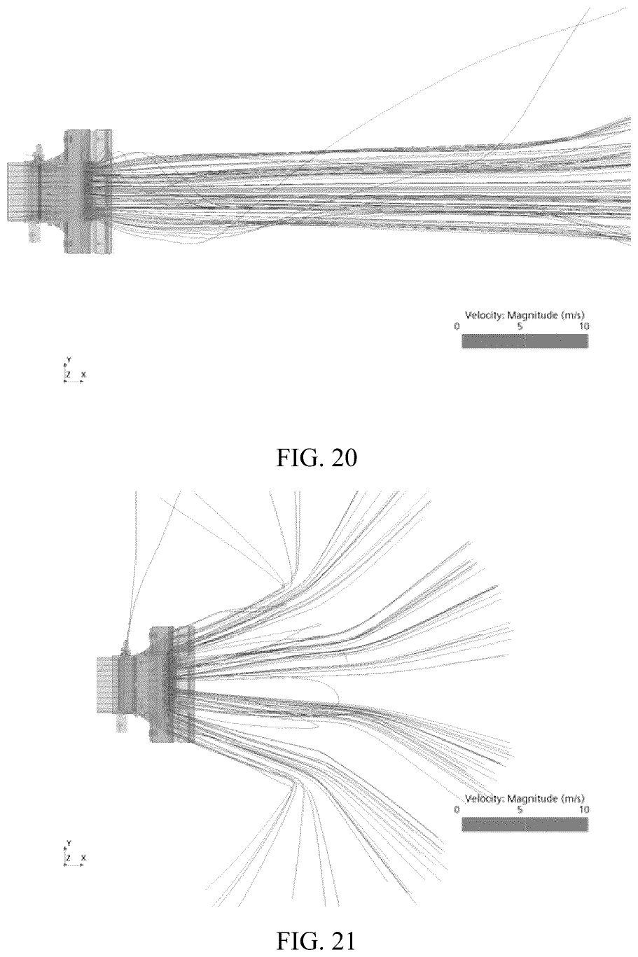

FIG. 20 shows a simulation of the pressure drop under the air drainage duct 2 without diffusion. Under other conditions being the same and without diffusion, the measured pressure drop is 111.5 Pa. FIG. 21 shows the simulated pressure drop under the air drainage duct 2 with diffusion. Under other conditions being the same and with diffusion, the measured pressure drop is 128.4 Pa. Therefore, the diffusion structure design of the air drainage duct 2 helps to reduce the impact of the pressure drop.

FIG. 9 shows details of the first air guide plate 31 shown in FIG. 3 in accordance with some embodiments. As shown, the first air guide plate 31 can include a first plate body 311, and on a same axis, a first connection structure 312 located on the first plate body 311, a second connection structure 313, and a third connection structure 314. The first connection structure 312 can include a first rotating shaft 3121 and a first driving part 3122 that are connected to each other. The third connection structure 314 can include a first shaft portion 3141, a first plate body 3142 and a second rotating shaft 3143. The first connection structure 312 can also include a through shaft hole 3123, and the first plate body 3142 can include the first chute 31421.

Arranged in sequence shown from left to right, the first rotating shaft 3121 and the second rotating shaft 3143 can be rotated on both sides of the air inlet duct 11 respectively, and the first driving part 3122 connects to a driving mechanism, so that the driving mechanism moves the first air guide plate 31 to rotate.

During application, a driving mechanism may be provided on one side wall of the air inlet duct 11. The driving mechanism may be connected to the first driving part 3122. When the driving mechanism is working, it can drive the first driving part 3122 to rotate, thereby driving the entire first air guide plate 31 to rotate. When rotating, the first air guide plate 31 maintains rotation through the first rotating shaft 3121 and the second rotating shaft 3143 respectively connected to the two side walls of the air inlet duct 11, and because the first rotating shaft 3121 and the second rotating shaft 3143 are in the same axis position, so that the first air guide plate 31 is more stable when performing a rotation action. Further, the first air guide plate 31 may include a first upper air guide plate 31a and a first lower air guide plate 31b that are opened and closed in opposite directions. During application, the first upper air guide plate 31a and the first lower air guide plate 31b move synchronously to control the middle air duct 13.

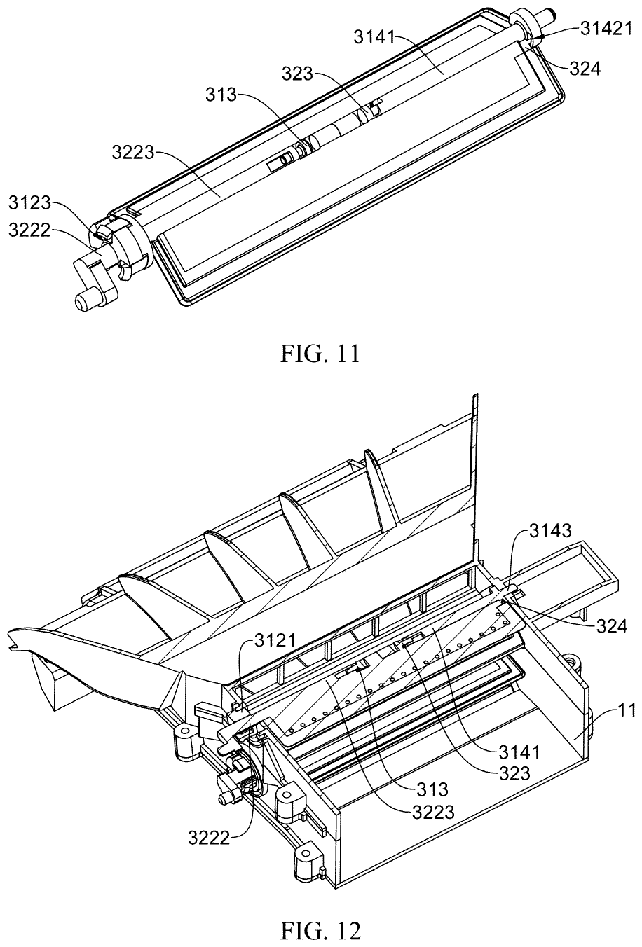

Referring to FIGS. 10 and 11, the second air guide plate 32 may include a second plate body 321, a fourth connection structure 322, a fifth connection structure 323, and a sixth connection structure 324. The fourth connection structure 322 may include the second driving part 3221, the third rotating shaft 3222, and the second shaft 3223. The third rotating shaft 3222 may be rotatably connected in the through shaft hole 3123, the sixth connecting structure 324 may be movably connected in the first chute 31421, and the second driving part 3221 may be connected to the driving mechanism so that the driving mechanism causes the second air guide plate 32 to rotate.

During application, the second air guide plate 32 may be connected to the first air guide plate 31 through the fit between the third rotating shaft 3222 and the through shaft hole 3123, and the fit between the sixth connecting structure 324 and the first slide groove 31421. The second air guide plate 32 can rotate independently relative to the first air guide plate 31. One driving mechanism at side of the air inlet duct 11 may be connected to the second driving part 3221. When the driving mechanism is operating, it can drive the second driving part 3221 to rotate and also drive the entire second air guide plate 32 to rotate.

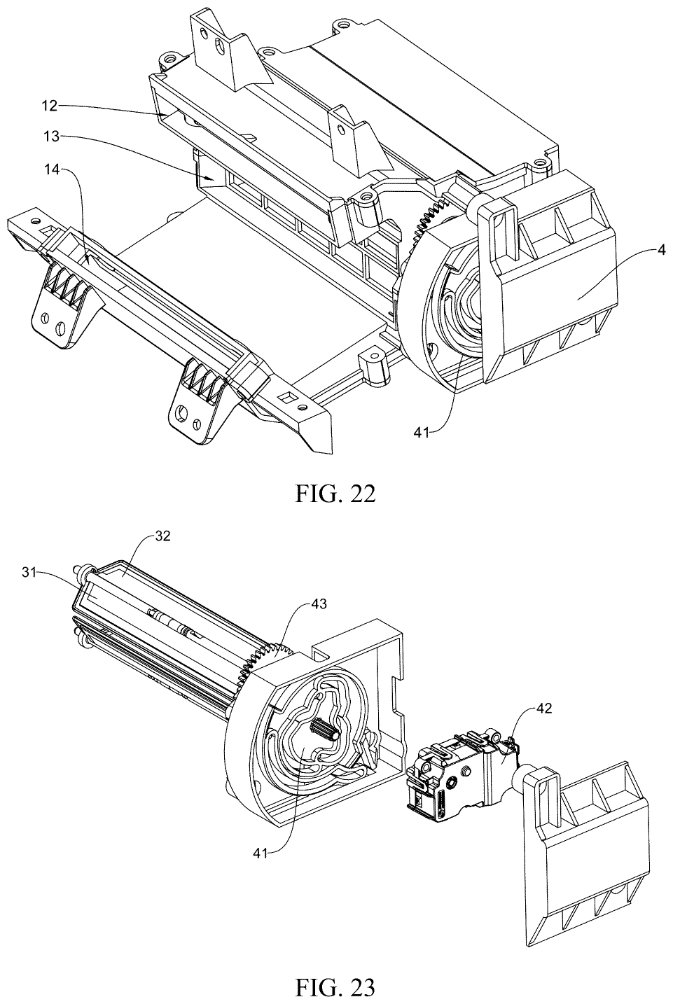

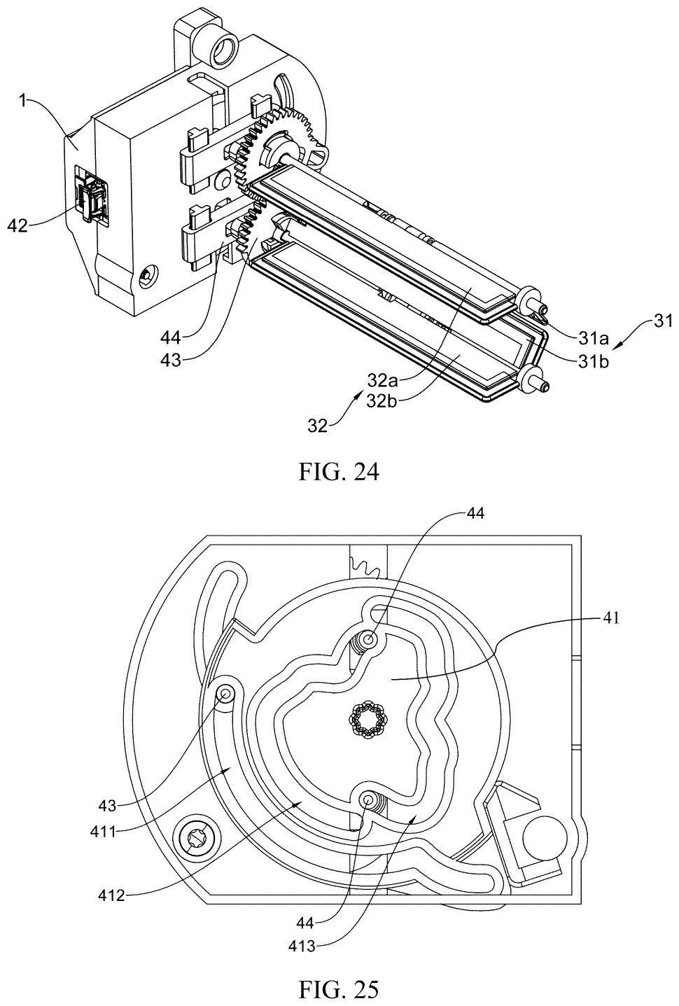

As shown in FIGS. 22-25, in the implementation, the driving mechanism 4 can be fixed at one side of the housing I to drive the air guide mechanism 3. The driving mechanism 4 can include a driving wheel plate 41, an actuator 42, and a set of first transmission parts 43 and two sets of second transmission parts 44. As shown in FIG. 25, the driving wheel plate 41 can include a first track groove 411, a second track groove 412, and a third track groove 413. The first track groove 411 can be connected to the first transmission part 43, which can be connected to the first air guide plate 31 (not shown in FIG. 25). The second track groove 412 can be connected to one set of second transmission parts 44, which may be connected to the second upper air guide plate 32a (not shown in FIG. 25). The third track groove 413 can be connected to another set of second transmission parts 44, which may be connected to the second lower air guide plate 32b (not shown in FIG. 25).

When the actuator 42 is running, it can drive the driving wheel plate 41 to rotate, and then drive the first upper air guide plate 31a and the first lower air guide plate 31b to open and close in opposite directions through the first track groove 411 and the cooperation of the first transmission part 43 to control the air outflow from the upper air duct 13. The second upper air guide plate 32a may be driven by the second track groove 412 and one of the second transmission parts 44 to control the air outflow from the upper air duct 12. The second lower air guide plate 32b may be driven by the third track groove 413 and another set of second transmission parts 44 to control the air outlet from the lower air duct 14.

Referring to FIGS. 11 and 12, the second shaft 3223 may be inserted into the end of the second connection structure 313, so that the second shaft 3223 can rotate around the end of the second connection structure 313. The end of the fifth connection structure 323 may be inserted into the first shaft 3141, so that the first shaft 3141 can rotate around the end of the fifth connection structure 323.

In some embodiments, the third rotating shaft 3222 and the sixth connection structure 324 are not on the same axis. In order to increase the stability of the second air guide plate 32 when rotating, there may be two or more fit groups between the first air guide plate 31 and the second air guide plate 32. One fit group may include thee connection structure 313 that fits with the second shaft 3223. Another fit group may include the fifth connection structure 323 that fits with the first shaft part 3141. The fit groups may be on the same axis as that of the third rotating shaft 3222, thereby increasing the stability of the first and second air guide plates 32 when rotating.

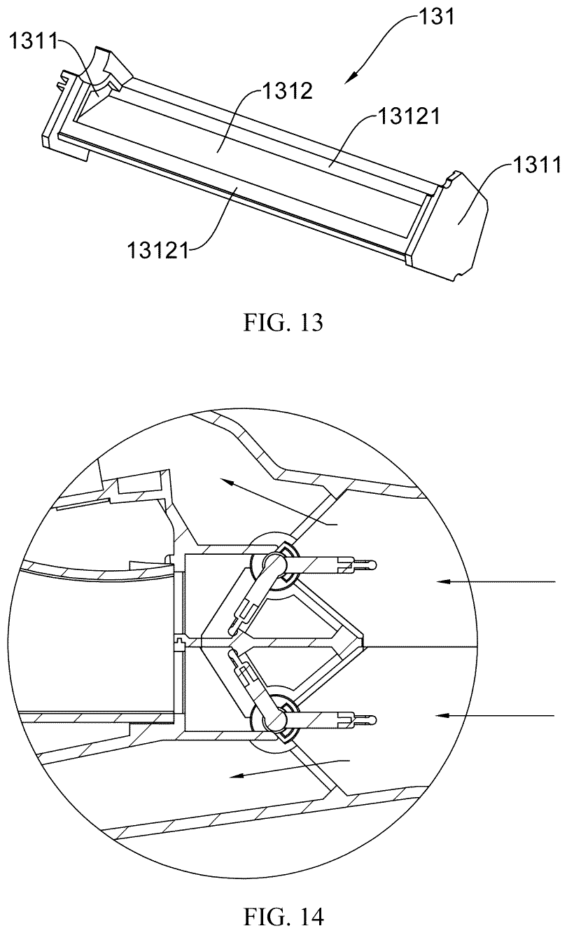

Referring to FIGS. 13 to 17, the middle air duct 13 may include baffle plate components 131. The baffle plate components 131 may include two installation plates 1311 at both sides of the air duct 13, and a baffle plate 1312 that is fixed to the two installation plates 1311. The baffle plate 1312 may divide the middle air duct 13 into upper and lower parts. Two or more sets of limited ribs 13121 at the upper and lower end surfaces of the baffle plate 1312 may connect the first air guide plate 31 and the second air guide plate 32.

When the first plate body 311 and the second plate body 321 rotate toward the baffle plate 1312, they will interfere with the limiting ribs 13121 at the extreme position of the movement, thereby increasing the sealing performance of the corresponding air duct and avoid air leaking.

The material of one side of the first plate body 311 and the second plate body 321 may be soft rubber or other compliant material. When the soft rubber or otherwise compliant material interferes with the limiting ribs 13121, the soft rubber or otherwise compliant material can improve the sealing effect by deformation.

It is worth mentioning that by the rotation of the first upper air guide plate 31a, the first lower air guide plate 31b, the second upper air guide plate 32a, and the second lower air guide plate 32b to control the upper air duct 12, the middle air duct 13, and the lower air duct 14 a variety of air flow modes can be provided according to user needs. Specifically, they include the following modes: (1) upper and lower blow mode; (2) upper only blow mode; (3) lower only blow mode; and (4) middle only blow mode.

As shown in FIG. 14, the upper air duct 12 and the lower air duct 14 are in an air blow mode. In this mode, the second upper air guide plate 32a and the second lower air guide plate 32b are both at horizontal positions, and the first upper air guide plate 31a and the first lower air guide plate 31b rotate toward the baffle plate 1312 respectively and interfere with the limiting ribs 13121. In this position, the upper air duct 12 and the lower air duct 14 are opened at the same time, the middle air duct 13 is closed, and the user obtains regular air flow from the two directions.

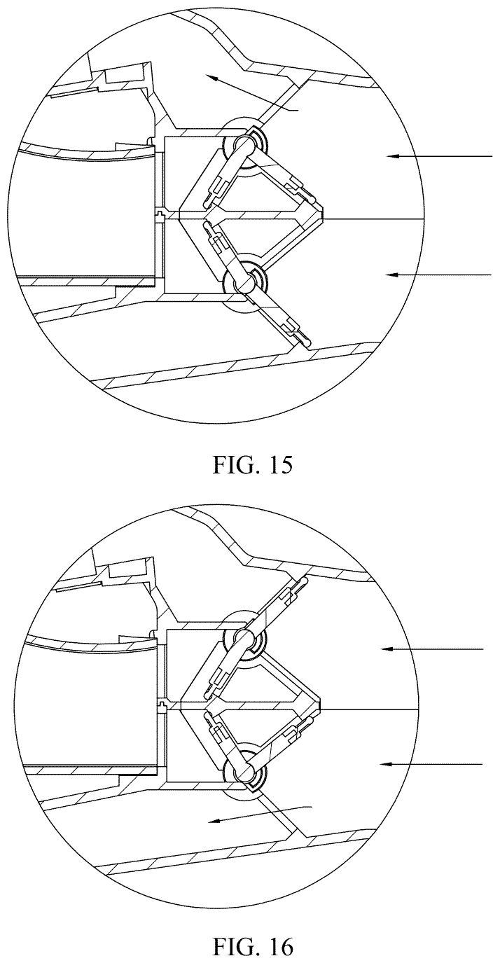

As shown in FIG. 15, the air flow mode of the upper air duct 12 is independent. In this mode, the second lower air guide plate 32b may be in a horizontal position, and the first upper air guide plate 31a and the first lower air guide plate 31b face the baffle plate 1312 to rotate separately and interfere with the limiting ribs 13121. The second upper air guide plate 32a rotates toward the baffle plate 1312 and interferes with the limiting ribs 13121, so that the upper air duct 12 is opened separately, and the lower air duct 14 and the middle duct 13 are closed at the same time. Thus, the user obtains regular air flow from only the upper air duct 12.

As shown in FIG. 16, the air flow mode of the lower air duct 14 is independent. In this mode, the upper second air guide plate 32 rotates upward and interferes with the upper wall of the upper air duct 12, and the lower second air guide plate 32b faces the baffle plate 1312 to rotate and interfere with the limiting protrusions 13121. The upper first air guide plate 31a and the lower first air guide plate 31b rotate toward the baffle plate 1312 and interfere with the limiting ribs 13121, so that the lower air duct 14 is opened independently, the upper air duct 12 and the middle air duct 13 are closed at the same time. Thus, the user obtains regular air flow only from the lower air duct 14.

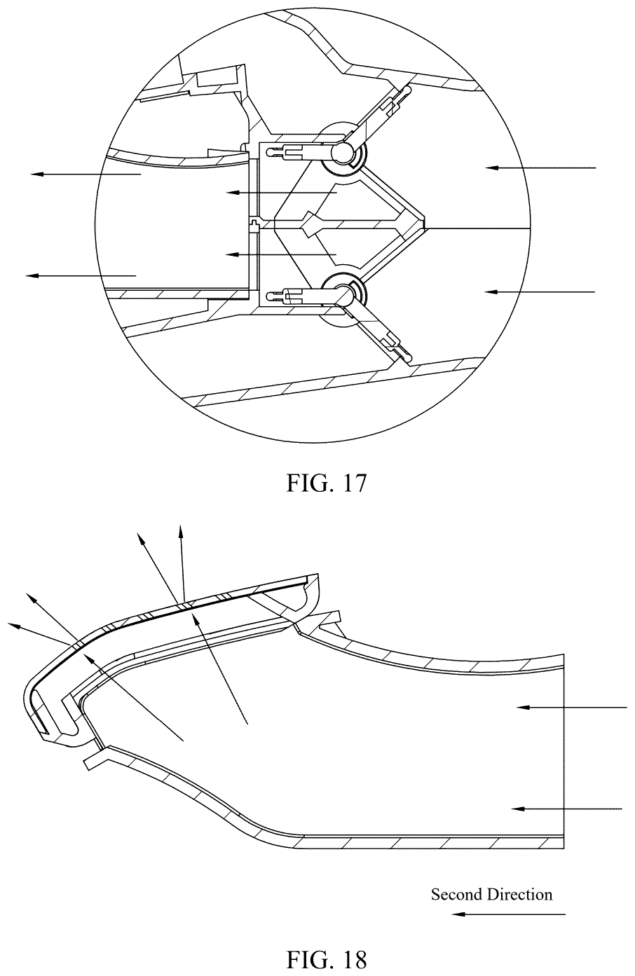

As shown in FIG. 17, the air flow mode of the middle air duct 13 is independent. In this mode, the second upper air guide plate 32a rotates upward and interferes with the upper wall of the upper air duct 12, and the second lower air guide plate 32b rotates downward and interferes with the lower wall of the leeward duct 14. The first upper air guide plate 31a and the first lower air guide plate 31b rotate in a direction away from the baffle plate 1312 and keep a horizontal position so that the middle duct 13 opens independently, and the upper air duct 12 and the lower air duct 14 are closed at the same time. Thus, a user obtains windless air flow only from the middle air duct 13.

The above only describes the best example of the present invention, but it should not be considered as limiting the claims. The present invention is not limited to the above example, and its specific structure is allowed to be changed. All changes made within the protection scope of the independent claims of the present invention are within the protection scope of the present invention.

What is claimed is:

1. A windless air outlet, comprising:
a housing including a plurality of ducts;
an installation space connected to a middle air duct of the plurality of ducts in the housing; and
an air drainage duct located at the installation space and including an air guide chamber and a windless board covering the air guide chamber; wherein
a cross-section of the air guide chamber in a first direction is trapezoidal such that an area increases in a second direction so that wind diffuses from a center of the air guide chamber to both sides of the air guide chamber during flow from an inlet of the air guide chamber to an outlet of the air guide chamber.

2. The windless air outlet of claim 1, wherein
the plurality of ducts includes an air inlet duct, an upper air duct, the middle air duct, and a lower air duct, and
the installation space is formed between the upper air duct and the lower air duct.

3. The windless air outlet of claim 1, wherein the air drainage duct is connected to the middle air duct.

4. The windless air outlet of claim 1, further comprising:
an air guide mechanism that includes a first air guide plate and a second air guide plate, wherein:
the first air guide plate includes a rotatable first upper air guide plate and a first lower air guide plate at both sides of an air inlet duct within the housing,
the upper first air guide plate and the lower first air guide plate control air from the middle air duct, and
the second air guide plate includes a second upper air guide plate configured to control air from an upper air duct within the housing and a second lower air guide plate configured to control air from lower air duct within the housing.

5. The windless air outlet of claim 4, wherein:
the first air guide plate includes a first plate body and a first connection structure located on the first plate body that is arranged sequentially along an axis with a second connection structure and a third connection structure.

6. The windless air outlet of claim 5, wherein:
the first connection structure includes a first rotating shaft and a first driving part that are connected to each other,
the third connection structure includes a first shaft, a first plate body, and a second rotating shaft arranged in sequence,
the first rotating shaft and the second rotating shaft are rotatable on both sides of the air inlet duct respectively, and
the first driving part connects the driving mechanism, so that the driving mechanism moves the first air guide plate to rotate.

7. The windless air outlet of claim 1, wherein the air guide chamber includes a middle flow channel and symmetrical multiple side flow channels on either side of the middle flow channel.

8. The windless air outlet of claim 7, wherein:
a central axis of the side flow channels and a central axis of the middle flow channel have an inclined angle, and
the inclined angle increases as a distance from the middle flow channel to the side flow channel increases.

9. The windless air outlet of claim 1, wherein:
the air guide chamber includes multiple air guide vanes such that the air guide chamber is divided into a middle flow channel and side flow channels by the multiple air guide vanes,
the multiple air guide vanes include inner air guide vanes and outer air guide vanes,
the air drainage duct includes the windless board, and
the windless board is supported by multiple outer air guide vanes.

10. The windless air outlet of claim 1, wherein:
the windless board includes a first windless board body and a secondary windless board body connected to each other at an obtuse angle,
both the first windless board body and the second windless board body include a plurality of through holes such that the plurality of through holes are distributed from an air outlet of a middle flow channel to air outlets of side flow channels, and
a size of the plurality of through holes decreases as a distance from the air outlet of the middle flow channel increases.

11. The windless air outlet of claim 2, wherein an air outlet area S1 of the upper air duct, an air outlet area S2 of the lower air duct, and an air outlet area S3 of the air drainage duct satisfies the following relationship: S1+S2≤S3.

12. The windless air outlet of claim 6, wherein the second air guide plate further includes:
a second plate body;
a fourth connection structure including a second drive part, a third rotating shaft, and a second shaft;
a fifth connection structure; and
a sixth connection structure.

13. The windless air outlet of claim 12, wherein:
the first connection structure includes a through shaft hole, and the first plate body includes a first chute,
the third rotating shaft is rotatably connected in the through shaft hole,
a sixth connecting structure is movably connected in the first chute, and
the second driving part connects to the driving mechanism so that the driving mechanism moves the second air guide plate to rotate.

14. The windless air outlet of claim 12, wherein:
the second shaft is disposed in an end of the second connection structure so that the second shaft can rotate around the end of the second connection structure,
an end of the fifth connection structure is disposed in the first shaft so that the first shaft can rotate around the end of the fifth connection structure.

15. The windless air outlet of claim 4, wherein:
the middle air duct includes baffle plate components, and
the baffle plate components include two installation plates, one at each side of the middle air duct, and a baffle plate that is fixed to the two installation plates.

16. The windless air outlet of claim 15, wherein:
the baffle plate divides the middle air duct into upper and lower parts,
a plurality of limited ribs are located at upper and lower end surfaces of the baffle plate that connects with the first air guide plate and the second air guide plate.
